(19) United States
(12) Patent Application Publication
(10) Pub. No.: US 2008/0172447 A1
(43) Pub. Date: Jul. 17, 2008

(54) Hierarchical Broadcast of Ui Assets

(75) Inventor: Richard M. Miller-Smith, Oxted (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,272

(22) PCT Filed: Feb. 23, 2005
(86) PCT No.: PCT/IB05/50660

§ 371 Date: Aug. 23, 2006

(30) Foreign Application Priority Data
Mar. 2, 2004 (GB) 0404657.9

(51) Int. Cl. G06F 15/16

(52) U.S. Cl. 709/203

(57) ABSTRACT

An audiovisual system (10) has a first client (14) and a second client (16), each client (14, 16) being connected to a server (12). The first client (14) includes a television (18), while the second client (16) includes a small screen (20) and a stereo system (22). The server (12) stores data representing items for example video programmes or pieces of music, the data including one or more assets (28) describing each item. An asset (28) may be, for example, the name of a video programme or piece of music; metadata of an item (for example the artist, year of production, or album); a still picture (an album cover or single frame of a video); or a background image or advertisement for a user interface. A client (14, 16) presents assets (28) to the user in the form of a hierarchical user interface (30). The user up-dates the user interface (30) each time he adds an item to, or removes an item from, the server (12), or edits an asset (28) already stored on the server (12). FIG. 2 depicts an exemplary hierarchical user interface (30), consisting of a network of nodes.

The present invention relates to an in-home audiovisual entertainment system including a server and one or more clients.

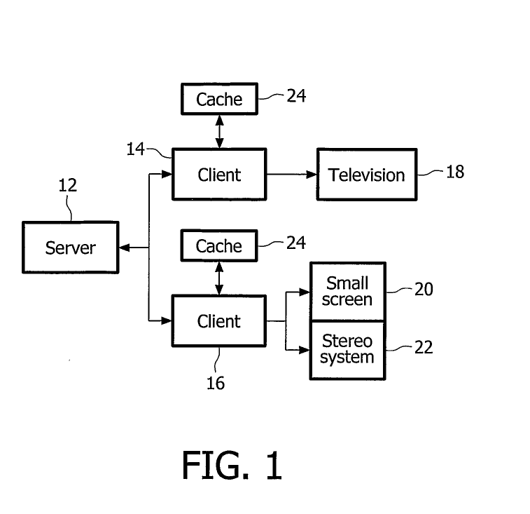

An exemplary audiovisual system of the type on which the present invention is based is depicted in FIG. 1. The system includes two clients, each client being connected to a server.

The server stores data representing such items as video programmes or pieces of music, which data is available for retrieval by one or more of the clients. The data representing each item stored on the server includes one or more assets describing that item. An asset may be, for example, the name of a video programme or piece of music.

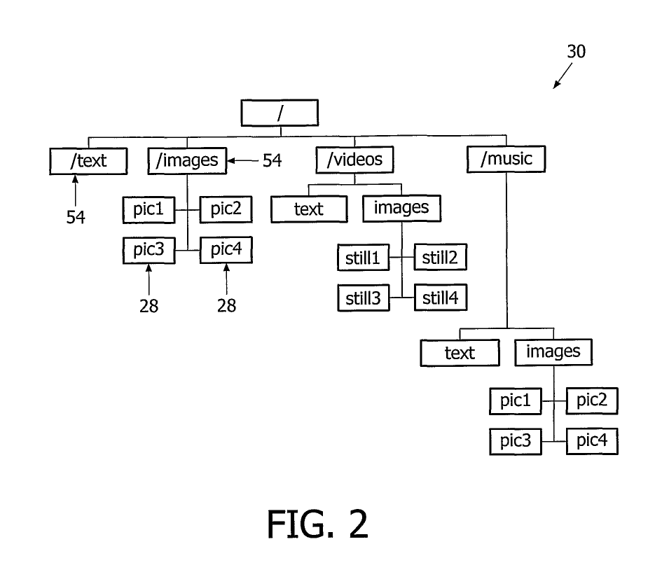

A client presents assets to the user in the form of a hierarchical user interface, such as that depicted in FIG. 2.

Since the assets are stored on the server but are used by a client each time a page of the user interface is rendered, a problem exists of how to transfer assets efficiently from the server to a client.

Conventionally, a client requests assets from the server each time it renders a page of the user interface. Such a transfer of information causes a noticeable delay, especially if the server is busy or the network is congested.

An object of the present invention is to provide the regular up-dating of user interface data in a server-client arrangement of electronic products.

Another object of the present invention is to provide up-dating of user interface data in a server-client arrangement of electronic products while maintaining network bandwidth to a minimum.

Another object of the present invention is to maintain the user interface data in electronic products in a server-client arrangement.

The present invention provides a method of updating user interface in a server-client system arrangement of electronic products, the method comprising: a server sends a message to the system concerning a node in a hierarchical array of a user interface, the message providing an indication of what is the most recent data for the user interface node, and the server monitors the system for a response to that message.

Preferably, in the method, if the server receives a response, the server sends the most recent data for that user interface node. The message includes information on the current data for the node and, if the client does not have that current data, a response is sent.

Advantageously the message-sending and response-monitoring operations are repeated for a number of nodes in the array.

The array may be arranged in a plurality of groups of user interface actions, and when a response has been received, the server sends a message concerning the next node in the same user interface group as the previous node; when no response has been received, the server sends a message concerning a node in a subsequent user interface group of array.

In the method, the server may send a message having data including a time stamp to indicate the last time that the data was up-dated. The method preferably includes storing data concerning the user interface nodes in a cache at a client.

The present invention also provides a computer program product directly loadable into the internal memory of a digital computer comprising software code portions for performing the method of the invention when said product is run on a computer.

The present invention also provides a computer program directly loadable into the internal memory of a digital computer, comprising software code portions for performing the method of the present invention when said program is run on a computer.

The present invention also provides a carrier, which may comprise electronic signals, for a computer program of the present invention.

The present invention also provides electronic distribution of a computer program product or a computer program or a carrier of the present invention.

The present invention also provides a system for updating user interface data in a server-client system arrangement of electronic products, the system comprising: a server to send a message to the system concerning a node in a hierarchical array of a user interface, the message providing an indication of what is the most recent data for the user interface node, the server to monitor the system for a response to the message.

In the system the server may have means to send the most recent data for that user interface node if the server receives a response; and/or means to repeat message-sending and response-monitoring operations for a number of nodes in the array.

The present invention also provides a server for a system for updating user interface data in a server-client arrangement system of electronic products, the server having means to send a message to the system concerning a node in a hierarchical array of a user interface, the message providing an indication of what is the most recent data for the user interface node, the server having means to monitor the system for a response to that message.

The present invention also provides a client for updating user interface data in a server-client system arrangement of electronic products, the client having means to receive a message to the system concerning a node in a hierarchical array of a user interface, the message providing an indication of what is the most recent data for the user interface node.

In this way, the present invention provides for the efficient and fast regular up-dating of user interface data in a server-client arrangement of electronic products.

An advantage of the present invention is that it ensures efficient and rapid up-dating of user information data.

Another advantage is that messages are sent only for that user interface data which is being currently used for the present configuration of products, and particularly for user interface data which is cached.

Another advantage is that if none of the client caches require up-dating, only a single message is transmitted.

Another advantage is that, if a client is busy, the system does not attempt to send data to it.

A further advantage is that the server is not affected if a client in the arrangement is switched off.

The present invention is applicable to arrangements of electronic products, especially in-house networking and audiovisual entertainment systems typically including televisions, video and DVD players, and audio systems.

The present invention may be implemented using standard TCP/IP networking, and the data can be transmitted within the server-client system using UDP broadcast packets.

FIG. 1 is a schematic diagram of an exemplary audiovisual system of the type on which the present invention is based;

FIG. 2 is a schematic diagram of an exemplary hierarchical user interface of the type on which the present invention is based;

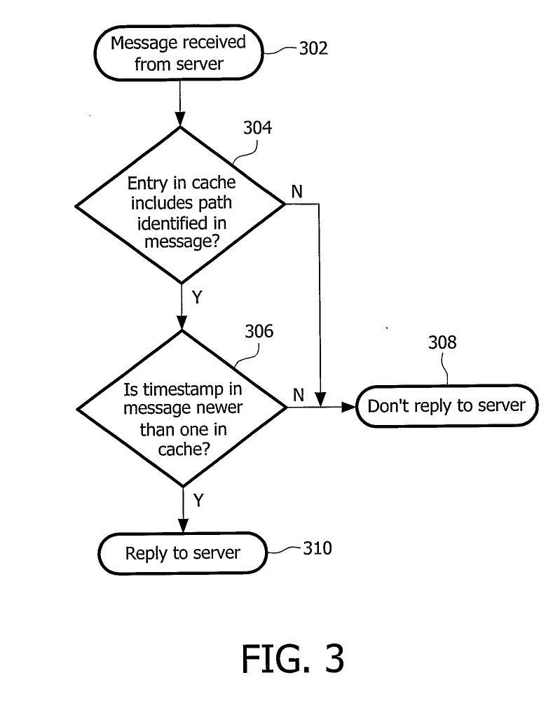

FIG. 3 is flowchart illustrating a method performed by a client according to a first embodiment of the invention;

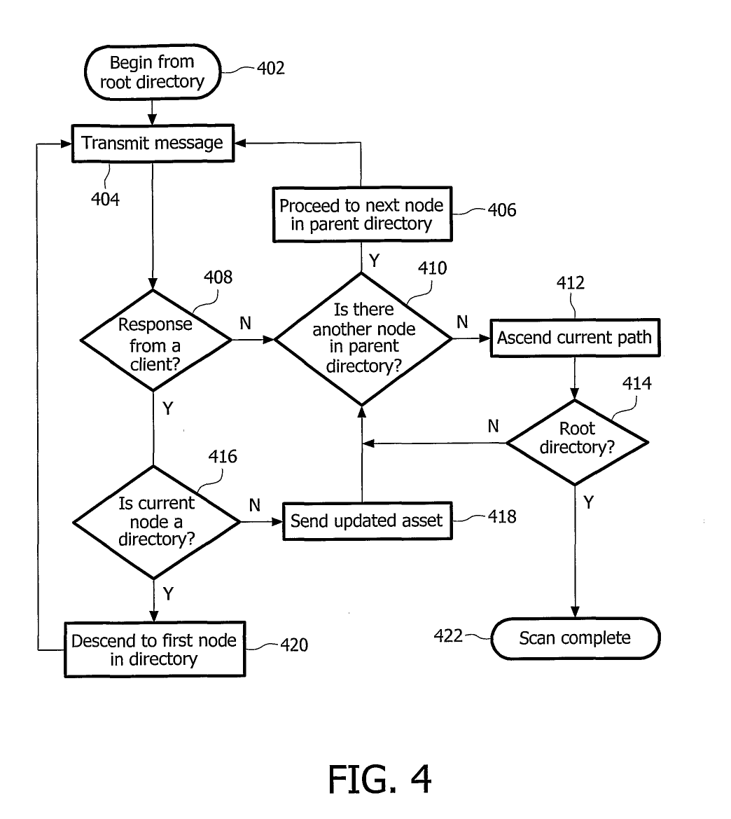

FIG. 4 is flowchart illustrating a method performed by a server according to a first embodiment of the invention;

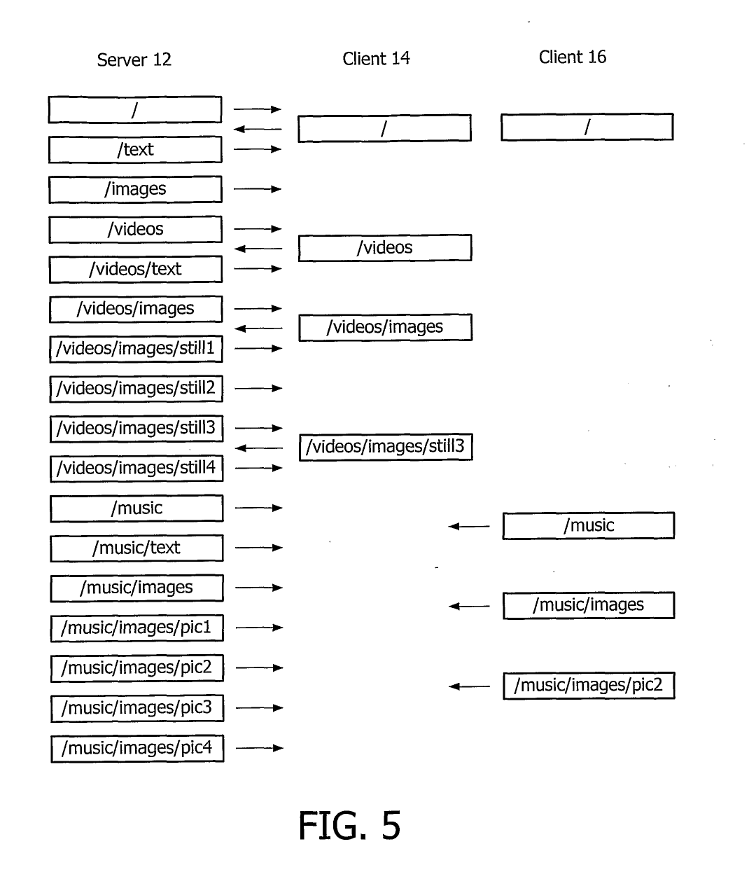

FIG. 5 represents transmissions in an exemplary scenario between elements of the audiovisual system of FIG. 1, the system employing the methods of FIGS. 3 and 4;

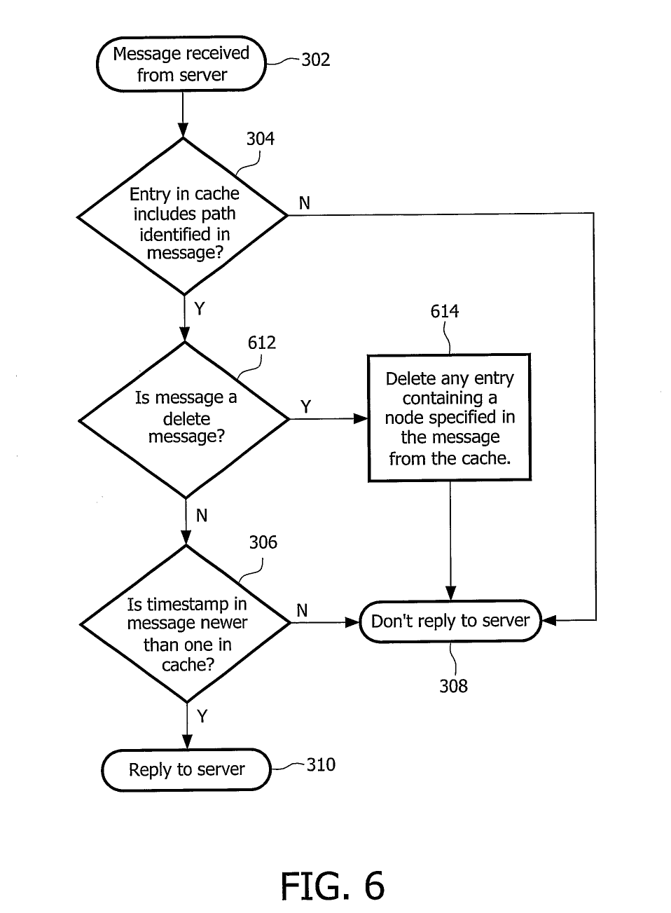

FIG. 6 is flowchart illustrating a method performed by a client according to a second embodiment of the invention; and

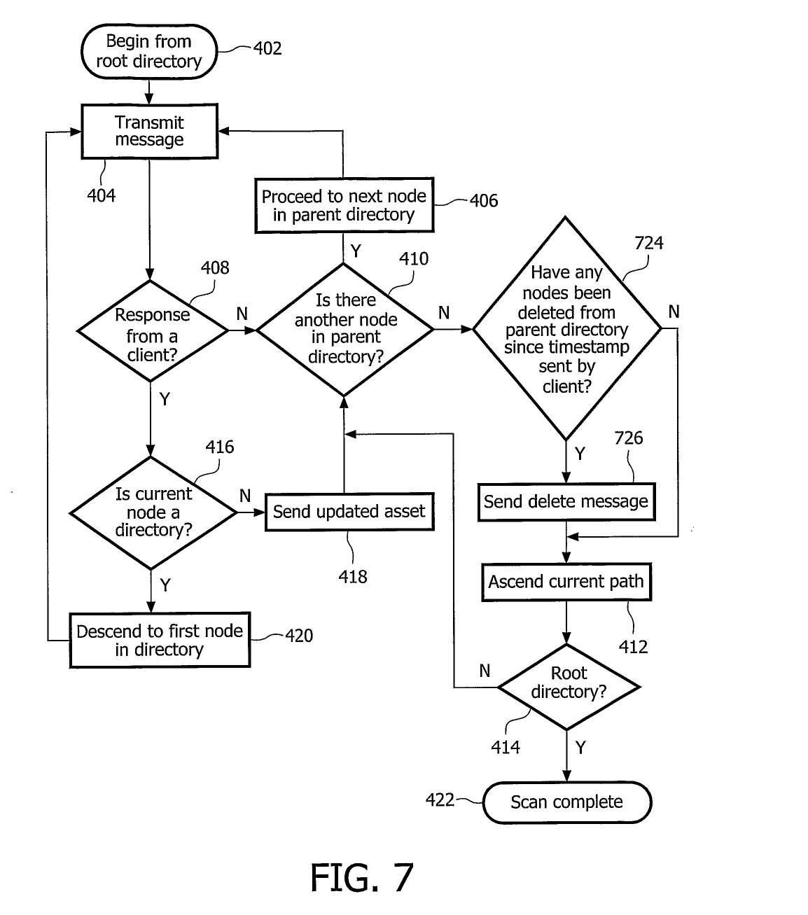

FIG. 7 is flowchart illustrating a method performed by a server according to a second embodiment of the invention.

FIG. 1 depicts an exemplary audiovisual system 10 including a first client 14 and a second client 16, each client 14, 16 being connected to a server 12. The first client 14 includes a television 18, while the second client 16 includes a small screen 20 and a stereo system 22.

The server 12 stores data representing items for example video programmes or pieces of music, the data including one or more assets 28 describing each item. An asset 28 may be, for example, the name of a video programme or piece of music; metadata of an item (for example the artist, year of production, or album); a still picture (an album cover or single frame of a video); or a background image or advertisement for a user interface.

A client 14, 16 presents assets 28 to the user in the form of a hierarchical user interface 30. The user up-dates the user interface 30 each time he adds an item to, or removes an item from, the server 12, or edits an asset 28 already stored on the server 12.

FIG. 2 depicts an exemplary hierarchical user interface 30, consisting of a network of nodes.

Each node of the user interface 30 is either a directory 54 or an asset 28. A directory 54 is capable of containing other directories 54, assets 28, or nothing, and is the means by which the user organises his assets 28 within the user interface 30. The user interface 30 consists of a root directory “/” containing several other directories 54, these being “/text”; “/images”; “/videos”; and “/music”. Some of these directories 54 contain further directories 54 and/or assets 28, for example the asset “pic1” in the directory “/images”. The position of a node of the user interface 30 is described by a path: the asset “pic1”, for example, is described by the path “/images/pic1”.

For each asset 28, the server 12 stores the path of the asset 28 and a timestamp indicating the last time that the asset 28 was up-dated.

Each client 14, 16 stores and maintains a cache 24. An entry in the cache 24 includes an asset 28, a path of the asset 28 and a timestamp indicating the last time the entry was up-dated. The cache 24 contains entries relating only to the assets 28 used by that client 14,16 which are most frequently requested by the user.

Since the assets 28 are stored primarily on the server 12 but are cached by the clients 14, 16, the cache 24 of each client 14, 16 must be regularly up-dated.

The server 12 includes a daemon 26 which periodically scans the user interface 30 stored on the server 12 and broadcasts a message to all clients 14, 16 each time it encounters a node. Each message broadcast by the daemon 26 includes a path of the node (for example “/images/pic1”); a timestamp indicating the last time that an asset 28 whose path includes that path was up-dated, whichever asset 28 was up-dated the latest; and an ID, which a client 14, 16 includes in its response, if any, to the message.

Upon receipt of such a message from the server 12, a client 14, 16, compares the contents of the message with the contents of its cache 24. Where the cache 24 contains an entry relating to an asset 28 whose path includes the path identified in the message, which asset 28 needs updating, (essentially that any node below it has a relevant entry) the client 14, 16 responds to the server 12. Otherwise, the client 14, 16 does not respond.

FIG. 3 is a flowchart illustrating in detail the method performed by a client 14, 16.

The client 14, 16 receives a message from the server 12 at step 302. At step 304 the client 14, 16 examines its cache 24: if there is no entry in the cache 24 which relates to an asset 28 whose path includes the path identified in the message, then at step 308 the client 14, 16 does not respond to the message. If at step 304 the cache 24 contains such an entry, at step 306 the client 14, 16 compares the timestamp contained in the message with the timestamp stored in the entry. If the timestamp stored in the entry is equal to that contained in the message, then at step 308 the client 14, 16 does not respond. If the timestamp stored in the entry is older than the one contained in the message, indicating that there is an out-of-date asset 28 including the path identified in the message, then at step 310 the client 14, 16 responds to the server 12. The client's 14, 16 response includes the ID included in the server's 12 message, by which ID the server 12 identifies which message, and thus which node, prompted the response.

A client 14, 16 may be too busy to respond or may be switched off. In such cases, the client 14, 16 does not respond to the message.

The server 12 waits a predetermined amount of time after sending a message.

If the server 12 receives no response to a message identifying a particular path, the daemon 26 proceeds to the next node, if there is one, in the same directory as the last. In this way, assets 28 or directories 54 where no up-date is required are avoided.

If the server 12 receives a response from a client 14, 16: where the node which prompted the response is a directory 54, the daemon 26 proceeds to the first node contained in that directory 54; where the node is an asset 28, the server transmits an up-dated asset 28 to the client 14, 16 which sent the response.

The daemon 26 continues until all out-of-date assets 28 are found and up-dated.

FIG. 4 is a flowchart illustrating in detail the method performed by the server 12 as described above.

The daemon 26 always begins from the root directory “/”.

Generally, whenever the daemon 26 encounters a node, at step 404 it transmits a message including the path of that node, as described above. If at step 408 the server 12 receives a response from a client 14, 16: where the node identified in the message is an asset 28, at step 418 an up-dated asset 28 is sent to the client 14, 16 which responded; where the node identified in the message is a directory 54, at step 420 the daemon 26 proceeds to the first node in that directory 54, before returning to step 404 to transmit a message identifying the path of that first node.

The daemon 26 proceeds, descending a path when a response from a client 14, 16 is received, ascending a path when there are no more nodes in the current parent directory 54, otherwise transmitting a message for each node in a particular parent directory 54. The method terminates when the daemon 26 ascends the hierarchy back to the root directory “/”.

In this way, all out-of-date assets 28 are found by the daemon 26, while paths of the hierarchy containing only up-to-date assets 28 are not searched. Clearly, if all nodes of the user interface 30 are associated with up-to-date assets 28, then the server 12 sends only one message identifying the root directory “/”.

FIG. 5 and the following description illustrate the transmissions which would occur between the server 12 and clients 14, 16 of the audiovisual system 10 of FIG. 1, the system 10 employing the methods of FIGS. 3 and 4, in an exemplary scenario where the assets 28 whose paths are “/videos/images/still3” and “/music/images/pic2” of the user interface 30 have been up-dated, the corresponding assets 28 stored in the respective cache 24 of each client 14, 16 thus being out-of-date. The asset “/videos/images/still3” is used by client 14, since client 14 includes the television 18, while the asset “/music/images/pic2” is used by client 16, since client 16 includes the small screen 20 and the stereo system 22.

The daemon 26 of the server 12 begins by broadcasting a message identifying the path “/” and containing a timestamp, the timestamp indicating the time at which either “/videos/images/still3” or “/music/images/pic2” was up-dated, whichever is later; this being the last time that an asset 28 whose path includes the path “/” was up-dated.

Both clients 14, 16 respond to this message, since each contains in its cache 24, for a node including the path “/”, a timestamp which is older than that contained in the message.

Since the path “/” relates to a directory 54, the daemon 26, after receiving a response from each client 14, 16, proceeds to the first node in that directory 54, the path of which node is “/text”.

Since no entry in the cache 24 of a client 14, 16 stores an asset 28 whose path includes that path (there is no asset 28 at all within the directory “/text”), no client 14, 16 responds.

The daemon 26 proceeds by transmitting a message identifying the path for each node in the root directory “/”, until it receives a response from client 14 to the message identifying the path “/videos”, since an asset 28 whose path includes that path has been up-dated, the path of the up-dated asset 28 being “/videos/images/still3”.

The daemon 26 continues until it transmits a message identifying the path “/videos/images/still3”, which path identifies an asset 28. The client 14 responds, since the entry in its cache 24 including the path “/videos/images/still3” includes a timestamp which is older than that contained in the message. The client's 14 response includes the ID included in the server's 12 message. Thus the server 12 identifies the asset “still3” in the cache 24 of client 14 as being out-of-date.

Once the server 12 receives the client's 14 response, it transmits to the client 14 data of the asset “/videos/images/still3” using a simple data transmission protocol.

The daemon 26 proceeds according to the method of FIG. 4 until the message identifying the path “/music/images/pic2” prompts the client 16 to respond, whereupon the server 12 transmits to the client 16 data of the asset “/music/images/pic2”.

According to a second embodiment of the invention, when a client 14, 16 responds to the server 12, it includes in its response the timestamp of the oldest entry in its cache 24. The server 12 identifies nodes which have been deleted since that time, and identifies these in a delete message to the client 14, 16, so that the client 14, 16 can delete entries relating to these nodes from its cache 24.

FIG. 6 is a flowchart illustrating in detail the method performed by a client 14, 16 according to the second embodiment of the invention.

Steps 302 to 310 are identical to those described above with reference to FIG. 3.

When a client 14, 16 receives a message from the server identifying a path, and the cache 24 of the client 14, 16 includes an entry including that path, then at step 612 the client 14, 16 determines whether the message is a delete message. If so, at step 614 any entry containing a node specified in the delete message is deleted from the cache 24.

FIG. 7 is a flowchart illustrating in detail the method performed by the server 12 according to the second embodiment of the invention.

Steps 402 to 422 are identical to those described above with reference to FIG. 4.

Where the daemon 26 at step 410 finds that there are no more nodes within the current parent directory, it proceeds to step 724 where it determines whether a node has been deleted from the parent directory since the time indicated in the client's 14, 16 response. If nodes have been deleted since the timestamp sent by the client 14, 16, the server 12 sends to that client 14, 16 a message indicating each node which has been deleted. Otherwise, the daemon 26 proceeds to step 412 as before.

In a variant, a response from a client 14, 16 to the server 12 includes the path of the node identified in the server's message: thus neither the server's nor the client's messages require the ID.

The client 14, 16 may respond using HTTP, in which case the client 14, 16 opens an HTTP connection to the server 12 and requests data for the asset 28 identified as being out-of-date.

The client 14, 16 may indicate in its response which nodes in its cache 24 that include the path indicated in the server's 12 message need updating, thus obviating the need for the daemon 26 to transmit a message for each node it encounters below that point in the hierarchy. Although such a system may at times run faster than the above-described embodiments, it is more complex and thus less scalable.

It will be apparent that a person skilled in the art could make minor modifications to the invention as described herein, which modifications, although departing from the literal wording of the following claims, are nonetheless within the intended meaning thereof.

1. A method of updating user interface data in a server-client system (10) arrangement of electronic products, the method comprising:
a server (12) sends a message to the system concerning a node (28, 54) in a hierarchical array of a user interface, the message providing an indication of what is the most recent data for the user interface node, and the server monitors the system for a response to that message.

2. A method according to claim 1 wherein, if the server (12) receives a response, the server sends the most recent data for that user interface node (28, 54).

3. A method according to claim 1 wherein the message includes information on the current data for the node (28, 54) and, if the client (14, 16) does not have that current data, a response is sent.

4. A method according to claim 1 wherein the message-sending and response-monitoring operations are repeated for a number of nodes (28, 54) in the array.

5. A method according to claim 1 wherein the array is arranged in a plurality of groups of user interface actions and, when a response has been received, the server (12) sends a message concerning the next node (28, 54) in the same user interface group as the previous node.

6. A method according to claim 1 wherein the array is arranged in a plurality of groups of user interface actions and, when no response has been received, the server (12) sends a message concerning a node (28, 54) in a subsequent user interface group of the array.

7. A method according to claim 1 comprising the server (12) sending a message having data including a time stamp to indicate the last time that the data was up-dated.

8. A method according to claim 1 storing data concerning the user interface nodes (28, 54) in a cache (24) at a client (14, 16).

9. A method according to claim 1 comprising the client (14, 16) indicating where in the array updating is required.

10. A method according to claim 1 wherein the client (14, 16) send information of the oldest data beneath the node for cache updating.

11. A computer program product directly loadable into the internal memory of a digital computer, comprising software code portions for performing the method of claim 1 when said product is run on a computer.

12. A computer program directly loadable into the internal memory of a digital computer, comprising software code portions for performing the method of claim 1 when said program is run on a computer.

13. A carrier, which may comprise electronic signals, for a computer program of claim 12.

14. Electronic distribution of a computer program product of claim 11.

15. A system (10) for updating user interface data in a server-client system (10) arrangement of electronic products, the system comprising:
a server (12) to send a message to the system concerning a node (28, 54) in a hierarchical array of a user interface, the message providing an indication of what is the most recent data for the user interface node, the server to monitor the system for a response to that message.

16. A system (10) according to claim 16 wherein the server (12) has means to send the most recent data for that user interface node (28, 54) if the server receives a response.

17. A system (10) according to claim 15 wherein the message includes information on the current data for the node (28, 54) and comprising means to send a response if the client does not have that current data.

18. A system (10) according to claim 15 comprising means to repeat message-sending and response-monitoring operations for a number of nodes (28, 54) in the array.

19. A system (10) according to claim 15 wherein the array is arranged in a plurality of groups of user interface actions and the server (12) has means to send a message concerning a node (28, 54) in the same user interface group as the previous node, when a response has been received.

20. A system (10) according to claim 15 wherein the array is arranged in a plurality of groups of user interface actions and the server (12) sends a message concerning a node (28, 54) in a subsequent user interface group of the array, when no response has been filed.

21. A server (12) for a system (10) for updating user interface data in a server-client arrangement of electronic products, the server having means to send a message to the system concerning a node (28, 54) in a hierarchical array of a user interface, the message providing an indication of what is the most recent data for the user interface node, the server having means to monitor the system for a response to that message.

22. A server (12) according to claim 21 wherein the server has means to send the most recent data for that user interface node (28, 54) if the server receives a response.

23. A server (12) according to claim 21 wherein the message includes information on the current data for the node (28, 54) and comprising means to send a response if the client does not have that current data.

24. A server (12) according to claim 21 comprising means to repeat message-sending and response-monitoring operations for a number of nodes in the array.

25. A server (12) according to claim 21 wherein the array is arranged in a plurality of groups of user interface actions and the server has means to send a message concerning a node (28, 54) in the same user interface group as the previous node, when a response has been received.

26. A server (12) according to claim 21 wherein the array is arranged in a plurality of groups of user interface actions and the server send a message concerning a node (28, 54) in a subsequent user interface group of the array, when no response had been filed.

27. A client (14, 16) for updating user interface data in a server-client system (10) arrangement of electronic products, the client having means to receive a message to the system concerning a node in a hierarchical array of a user interface, the message providing an indication of what is the most recent data for the user interface node.

28. A client (14, 16) according to claim 27 comprising means to send a response to a message if the client does not have the current data for that node (28, 54).

29. A client (14, 16) according to claim 27 wherein the array is arranged in a plurality of groups for user interface actions and a server (12) has means to send a message concerning a node in the same user interface group as the previous node, when a response has been received.

30. A client (15, 16) according to claim 27 wherein the array is arranged in a plurality of groups of user interface actions and a server sends a message concerning a node in a subsequent user interface group of the array, when no response has been filed.
